(19) United States
(12) Patent Application Publication
(10) Pub. No.: US 2025/0256567 A1
(43) Pub. Date: Aug. 14, 2025

(54) ELECTRIC TRANSMISSION AND WORK VEHICLE INCLUDING THE SAME

(71) Applicant: KANZAKI KOKYUKOKI MFG. CO., LTD., Amagasaki-shi (JP)

(72) Inventors: Koji IWAKI, Amagasaki-shi (JP); Hitoshi ADACHI, Amagasaki-shi (JP); Akihiro IMA, Amagasaki-shi (JP); Toshinobu SHINOHARA, Amagasaki-shi (JP); Noriyuki YAMAGISHI, Amagasaki-shi (JP)

(21) Appl. No.: 19/037,516

(22) Filed: Jan. 27, 2025

(30) Foreign Application Priority Data
Feb. 13, 2024 (JP) 2024-019130

(51) Int. Cl. B60K 17/356; B60K 1/02; B60K 17/08; B60K 17/28; B60K 17/344; F16H 37/08

(52) U.S. Cl. CPC B60K 17/356; B60K 1/02; B60K 17/08; B60K 17/28; B60K 17/344; F16H 37/0806

(57) ABSTRACT

[Problem] An electric transmission is to be shared among different models and specifications, and can be easily adapted to, for example, a plurality of models and specifications of a work vehicle only by developing variations of power transmissions such as a transmission case excluding the electric transmission. [Solution] The electric transmission includes a work electric motor, a travel electric motor, and a power combining mechanism that combines the output of the electric motors. The output of the power combining mechanism is changeable by variably controlling at least the output of the travel electric motor. The electric motors and the power combining mechanism are assembled in a common casing to form a unit. The output of the work electric motor and the output of the power combining mechanism can be respectively taken out from the casing.

### CROSS REFERENCE TO RELATED APPLICATIONS

The present invention claims priority under 35 U.S.C. § 119 to Japanese Application No. 2024-019130, filed on Feb. 13, 2024, the entire contents of which being incorporated herein by reference.

### TECHNICAL FIELD

The present invention relates to an electric transmission and a work vehicle including the same.

### BACKGROUND ART

In recent years, motorization of power sources mounted on various work vehicles has been promoted as a countermeasure against global warming, exhaust gas regulations, and the like. For example, Patent Document 1 discloses a work vehicle including a work electric motor, a travel electric motor, and a planetary gear mechanism that combines outputs of the electric motors, in which a portion of the output of the work electric motors is transmitted to a work drive system, and a combined output of the planetary gear mechanism is transmitted to a travel drive system.

### PRIOR ART DOCUMENT

### Patent Document

Patent Document 1: Japanese Unexamined Patent Application Publication No. 2013-141955

### SUMMARY OF INVENTION

### Technical Problem

In recent work vehicles, it is strongly demanded to contribute to cost reduction and effective use of resources by weight reduction and simplification of manufacturing processes. For this purpose, it is considered desirable that not only a platform (a basic portion of machine body design) but also a power transmission such as a transmission case can be shared as much as possible between models.

However, in general, the power transmission of a work vehicle is usually different for each model or each specification in accordance with the type, capability, and the like of the work to be executed. In the configuration of Patent Document 1, a dedicated structure is established for each model or each specification such that two electric motors are disposed in a front portion of a transmission case, and a planetary gear mechanism, a forward/reverse switching gear mechanism, a sub-transmission gear mechanism, and the like are accommodated in the transmission case. That is, no consideration is given to commonality of members, easiness of development of variations, and the like. For this reason, the demand for cost reduction and effective use of resources, which has increased in recent years, is not met, and there is room for improvement.

### Solution to Problem

It is a technical object of the present invention to provide an electric transmission and a work vehicle including an electric transmission improved by studying the current situation described above.

An electric transmission according to a first aspect of the present invention includes: a work electric motor; a travel electric motor; and a power combining mechanism that combines output of both of the electric motors, wherein, at least the output of the travel electric motor is variably controlled to change the output of the power combining mechanism, both of the electric motors and the power combining mechanism are assembled in a common casing to form a unit, and the output of the work electric motor and the output of the power combining mechanism are respectively taken out from the casing.

In an electric transmission according to a second aspect of the present invention, a work-machine drive shaft to which the output of the work electric motor is transmitted and a travel drive shaft to which the output of the power combining mechanism is transmitted are supported in parallel by the casing and protrude outward in the same direction.

In an electric transmission according to a third aspect of the present invention, rated power output of the work electric motor is greater than rated power output of the travel electric motor.

In an electric transmission according to a fourth aspect of the present invention, the power combining mechanism is structured such that transmission output of the power combining mechanism is maximized when the output of the travel electric motor is maximized in one direction, and transmission output of the power combining mechanism is minimized or zero when the output of the travel electric motor is maximized in another direction.

A work vehicle according to a fifth aspect of the present invention includes the electric transmission according to any one of the first to fourth aspects, and a machine body frame. In this case, the electric transmission is structured to be supported on the machine body frame in a vibration-proof manner via a pair of vibration isolating members on at least right and left outer side portions of the casing.

### Advantageous Effects of Invention

According to the present invention, both electric motors and a power combining mechanism are assembled to a common casing to form a unit, and the output of the work electric motor and the output of the power combining mechanism can be respectively taken out from a casing, so that both electric motors and the power combining mechanism can be easily assembled to a power transmission such as a transmission case as a single unit of an electric transmission. That is, the electric transmission can be shared among different models and specifications, and can be easily adapted to, for example, a plurality of models and specifications of a work vehicle only by developing variations of power transmissions such as the transmission case except for the electric transmission. Therefore, the assembling workability (assembling efficiency) can be improved, and the cost for developing variations can be reduced.

### BRIEF DESCRIPTION OF DRAWINGS

FIG. 1 is an overall side view of an agricultural tractor according to a first embodiment.

FIG. 2 illustrates a power transmission system of the agricultural tractor.

FIG. 3 illustrates a power transmission system of an electric transmission.

FIG. 4 is a partially cutaway transverse cross-sectional view of the electric transmission.

FIG. 5 is an output characteristic diagram illustrating the relationship between the traveling speed of the agricultural tractor and the output of a travel electric motor.

FIG. 6 illustrates a power transmission system of an agricultural tractor according to a second embodiment.

FIG. 7 illustrates a power transmission system of an electric transmission.

FIG. 8 is a partially cutaway transverse cross-sectional view of the electric transmission.

FIG. 9 illustrates a power transmission system of an agricultural tractor according to a third embodiment.

FIG. 10 is a longitudinal cross-sectional view of a traveling machine body illustrating a support structure of an electric transmission.

FIG. 11 illustrates a power transmission system of an agricultural tractor according to a fourth embodiment.

FIG. 12 illustrates a power transmission system of an electric transmission.

FIG. 13 is an output characteristic diagram illustrating the relationship between the traveling speed of the agricultural tractor and the output of a travel electric motor.

### DESCRIPTION OF EMBODIMENTS

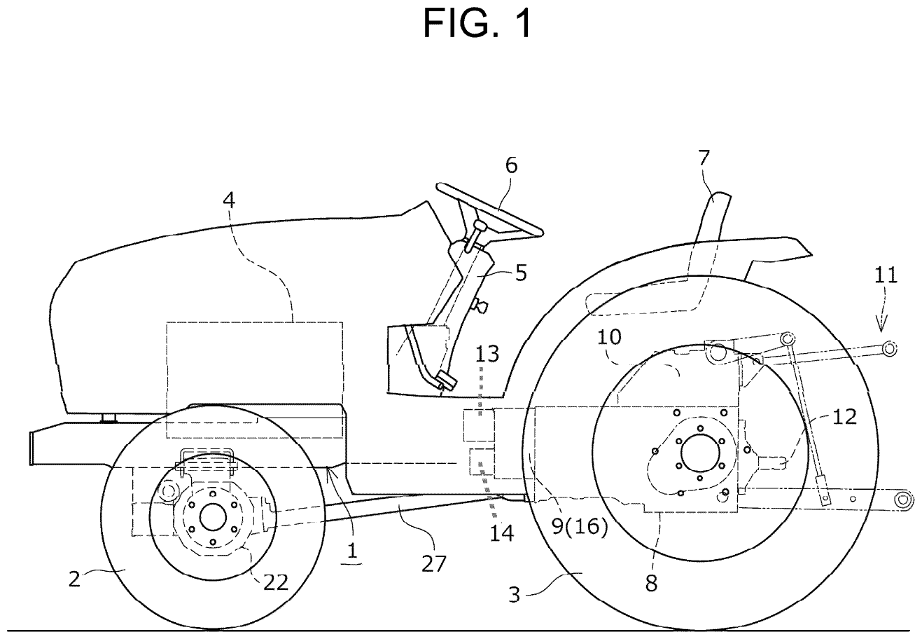

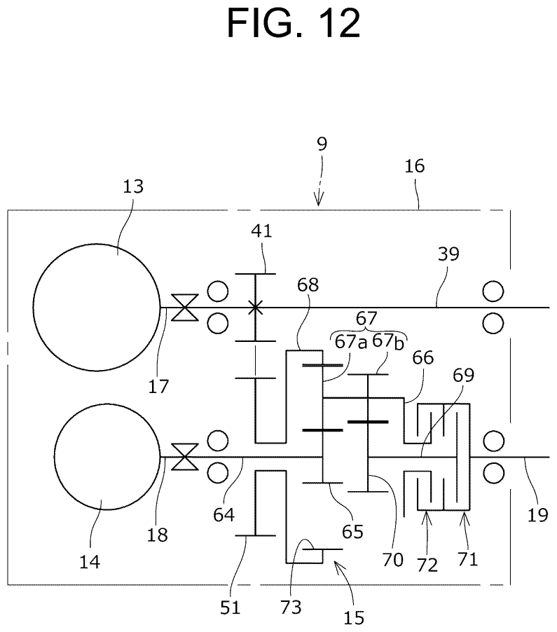

An electric transmission of an agricultural tractor for agricultural work (hereinafter, simply referred to as “agricultural tractor”), which is an example of a work vehicle, according to embodiments of the present invention is embodied will now be described with reference to the drawings (FIG. 1 to FIG. 13). In the following description, the terms “front and rear,” “left and right,” and “up and down” are used to specify directions. These are defined with reference to the forward direction of a traveling machine body 1. However, these terms are used for convenience of description and do not limit the technical scope of the present invention.

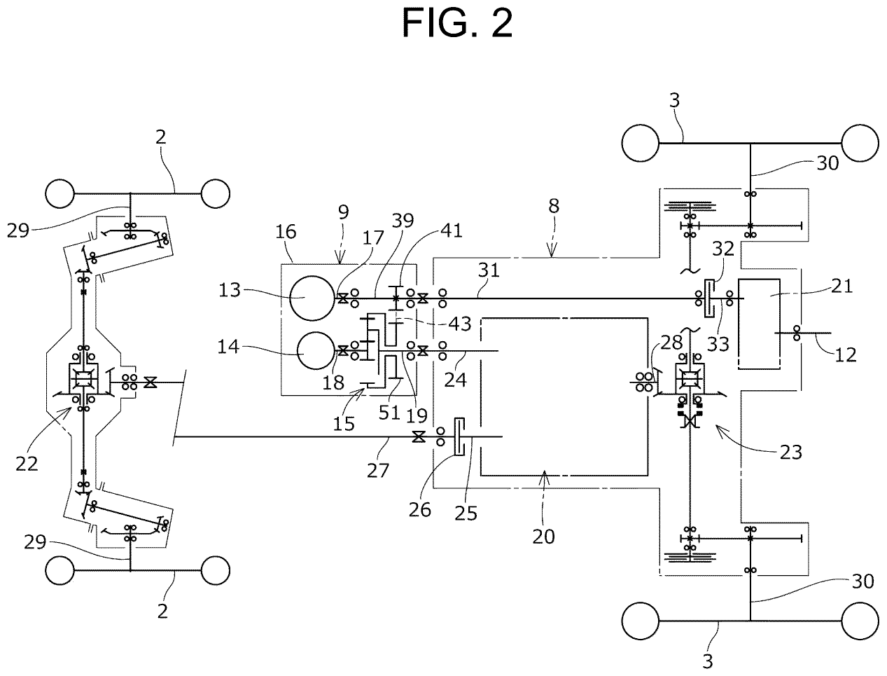

First, an outline of an agricultural tractor will be described with reference to FIG. 1 and FIG. 2. As illustrated in FIG. 1 and FIG. 2, a traveling machine body 1 of the agricultural tractor according to a first embodiment is supported by a pair of left and right front wheels 2 and a pair of left and right rear wheels 3, which are traveling parts. A chargeable and dischargeable power supply device 4 (battery) formed of a secondary battery, a large-capacity capacitor, or the like, and a steering column 5 including a steering handle 6 are provided on a front portion of an upper surface of the traveling machine body 1.

A steering seat 7 is disposed behind the steering handle 6. When an operator seated on the steering seat 7 turns the steering handle 6, the steering angle (operation angle) of the right and left front wheels 2 changes in accordance with the amount of turning operation. A machine body frame of the traveling machine body 1 has a monocoque structure, and a transmission case 8 accommodating the front wheels 2, the rear wheels 3, a gear transmission mechanism for transmitting a driving force to a ground work machine (not illustrated), and the like is mounted on a rear portion of the machine body frame. Reference numeral 9 denotes an electric transmission according to the present invention, which functions as a drive source of the front wheels 2, the rear wheels 3, and the ground work machine, as will be described later. The electric transmission 9 is mounted on a front surface of the transmission case 8.

A hydraulic lifting mechanism 10 that lifts and lowers a ground work machine (not illustrated) such as a rotary tiller connected to a rear portion of the traveling machine body 1 is detachably attached to an upper surface of a rear portion of the transmission case 8. The ground work machine is connected to the rear of the transmission case 8 via a three-point link mechanism 11. A PTO shaft 12 that transmits a PTO driving force to the ground work machine is provided on a rear surface of the transmission case 8 so as to protrude rearward.

Next, a power transmission system of the agricultural tractor will be described with reference to FIG. 2 to FIG. 4. The agricultural tractor of the first embodiment is structured such that the output from the electric transmission 9 is distributed to the front wheels 2, the rear wheels 3, and the PTO shaft 12. In the first embodiment, the electric transmission 9, which transmits a driving force to the front wheels 2, the rear wheels 3, and the ground work machine (not illustrated) is mounted on the front surface side of the transmission case 8. As will be described later, the electric transmission 9 may be mounted on the machine body frame in a state where the electric transmission 9 is separated from the transmission case 8 and a power transmission state is maintained via a universal joint.

The electric transmission 9 includes a work electric motor 13 and a travel electric motor 14 as power sources, and a planetary gear mechanism 15 as a power combining mechanism that combines outputs of the electric motors 13 and 14. The electric transmission 9 in this case is a unit in which the work electric motor 13, the travel electric motor 14, and the planetary gear mechanism 15 are assembled in a common casing 16.

The electric transmission 9 has two paths: a power transmission path via a work motor shaft 17 and a work-machine drive shaft 39 projecting rearward from the work electric motor 13, and a power transmission path via a travel drive shaft 19 extending rearward from the planetary gear mechanism 15. That is, the output of the work electric motor 13 and the combined output (transmission output) of the planetary gear mechanism 15 are each taken out from the casing 16 to the outside and transmitted to the transmission case 8.

The electric transmission 9 is formed such that a portion of the output via the work motor shaft 17 and the output via a travel motor shaft 18 are combined by the planetary gear mechanism 15, and the front wheels 2 and the rear wheels 3 are rotationally driven by the combined output (transmission output) via the travel drive shaft 19 extending rearward from the planetary gear mechanism 15. The electric transmission 9 is formed to rotationally drive the PTO shaft 12 only by the remaining output of the work electric motor 13 via the work motor shaft 17. The travel motor shaft 18 protrudes rearward from the travel electric motor 14.

In this case, the combined output of the planetary gear mechanism 15 can be shifted by changing and controlling at least the output rotation of the travel electric motor 14. The work electric motor 13 of the first embodiment is formed to keep the output (rotational speed) substantially constant regardless of load fluctuation. The travel electric motor 14 of the first embodiment is formed such that the rotation direction can be reversed and the output rotation can be changed steplessly (continuously) from zero to a predetermined maximum speed.

In the first embodiment, the rated output of the work electric motor 13 is larger than the rated output of the travel electric motor 14. In other words, the work electric motor 13 has a larger capacity than the travel electric motor 14. A drive source (for example, an internal combustion engine) in a work vehicle such as an agricultural tractor needs to have a capability to be used for driving a work machine and a capability to be used for traveling drive. In order to cover these two capabilities with a single electric motor, a considerably large capacity is required, resulting in a high cost. According to the present invention, by setting the capacity of the work electric motor 13 having the ability to be used for driving a work machine such that the work electric motor 13 has a portion of the ability necessary for traveling drive, it is possible to provide a compact drive source with reduced cost as a whole.

The transmission case 8 disposed at the rear of the traveling machine body 1 accommodates a forward/reverse switching and sub-transmission gear mechanism 20 that switches the output via the travel drive shaft 19 to the forward or reverse direction and changes the speed, a rear axle mechanism 23 that transmits the output via the forward/reverse switching and sub-transmission gear mechanism 20 to the left and right rear wheels 3, and a PTO transmission gear mechanism 21 that appropriately changes the speed of the output via the work motor shaft 17 and transmits the resulting output to the PTO shaft 12. A front portion of the traveling machine body 1 is provided with a front axle mechanism 22 that transmits the power via the sub-transmission gear mechanism 20 to the left and right front wheels 2.

The travel drive shaft 19 of the planetary gear mechanism 15 is interlockingly connected to a travel input shaft 24 protruding forward from the forward/reverse switching and sub-transmission gear mechanism 20. A front-wheel output shaft 25 projects forward from the forward/reverse switching and sub-transmission gear mechanism 20. The front-wheel output shaft 25 is interlockingly connected to the front axle mechanism 22 in a front portion of the traveling machine body 1 via a front-wheel drive clutch 26 and a front-wheel propeller shaft 27. A travel output shaft 28 projects rearward from the forward/reverse switching and sub-transmission gear mechanism 20. The travel output shaft 28 is interlockingly connected to the rear axle mechanism 23.

The combined output transmitted from the travel drive shaft 19 of the planetary gear mechanism 15 to the forward/reverse switching and sub-transmission gear mechanism 20 is branched and transmitted to the front wheels 2 side and the rear wheels 3 side. The output directed to the front wheels 2 is transmitted from the front-wheel output shaft 25 of the forward/reverse switching and sub-transmission gear mechanism 20 to a front wheel drive shaft 29 rotatably supporting the left and right front wheels 2 via the front-wheel drive clutch 26, the front-wheel propeller shaft 27, and the front axle mechanism 22, thereby rotationally driving the left and right front wheels 2. The output directed toward the rear wheels 3 is transmitted from a travel output shaft 28 of the forward/reverse switching and sub-transmission gear mechanism 20 to a rear wheel drive shaft 30 rotatably supporting the left and right rear wheels 3 via the rear axle mechanism 23, thereby rotationally driving the left and right rear wheels 3.

The work motor shaft 17 of the work electric motor 13 is interlockingly connected to the front portion side of a PTO transmission shaft 31 extending in the front-rear direction in the transmission case 8 via the work-machine drive shaft 39 described later. The rear portion side of the PTO transmission shaft 31 is interlockingly connected to a PTO input shaft 33 protruding forward from the PTO transmission gear mechanism 21 via a PTO clutch 32. The PTO shaft 12 projects rearward from the PTO transmission gear mechanism 21 to the outside of the transmission case 8. The output transmitted from the work motor shaft 17 of the work electric motor 13 to the PTO transmission shaft 31 is transmitted to the PTO transmission gear mechanism 21 via the PTO clutch 32 and the PTO input shaft 33 to rotationally drive the PTO shaft 12.

Next, a detailed structure of the electric transmission 9 will be described with reference to FIG. 2 to FIG. 4. As described above, the electric transmission 9 is a unit in which the work electric motor 13 and the travel electric motor 14, which are power sources, and the planetary gear mechanism 15, which is a power combining mechanism, are assembled in the common casing 16. In the first embodiment, the casing 16 of the electric transmission 9 is composed of two shell-like members, i.e., a main body portion 34 that is deep and opens rearward, and a lid portion 35 that covers and closes the opening of the main body portion 34 and is shallower than the main body portion 34. Although not illustrated, the main body portion 34 and the lid portion 35 are bolted together. Various shafts, gears, and the like are disposed inside the casing 16 in a state where the main body portion 34 is closed by the lid portion 35.

The work electric motor 13 and the travel electric motor 14 are mounted on the front surface side of the main body portion 34 of the casing 16 so as to be arranged vertically. The work motor shaft 17 of the work electric motor 13 penetrates a front wall 36 of the main body portion 34. The distal end side of the work motor shaft 17 protrudes into the casing 16. The work motor shaft 17 is rotatably supported by the front wall 36 of the main body portion 34 via a sealed bearing 37. Similarly, the travel motor shaft 18 of the travel electric motor 14 also passes through the front wall 36 of the main body portion 34, and the distal end side thereof protrudes into the casing 16. The travel motor shaft 18 is also rotatably supported by the front wall 36 of the main body portion 34 via a sealed bearing 38.

The work-machine drive shaft 39 coaxially connected to the work motor shaft 17 is rotatably supported in an upper portion of the casing 16. The distal end side of the work motor shaft 17 is spline-engaged with the proximal end side of the work-machine drive shaft 39 so as to be relatively non-rotatable. Therefore, the work-machine drive shaft 39 rotates integrally with the work motor shaft 17. The work-machine drive shaft 39 penetrates through the lid portion 35, and the distal end side thereof protrudes to the outside from the casing 16. In the present invention, the term “work-machine drive shaft extending from the work electric motor 13” is used as a broader concept of the work motor shaft 17 and/or the work-machine drive shaft 39. An opening portion of the lid portion 35 through which the work-machine drive shaft 39 is inserted is closed by an annular seal 40 fitted on the work-machine drive shaft 39. An output branching gear 41 is fixed to a longitudinally intermediate portion of the work-machine drive shaft 39.

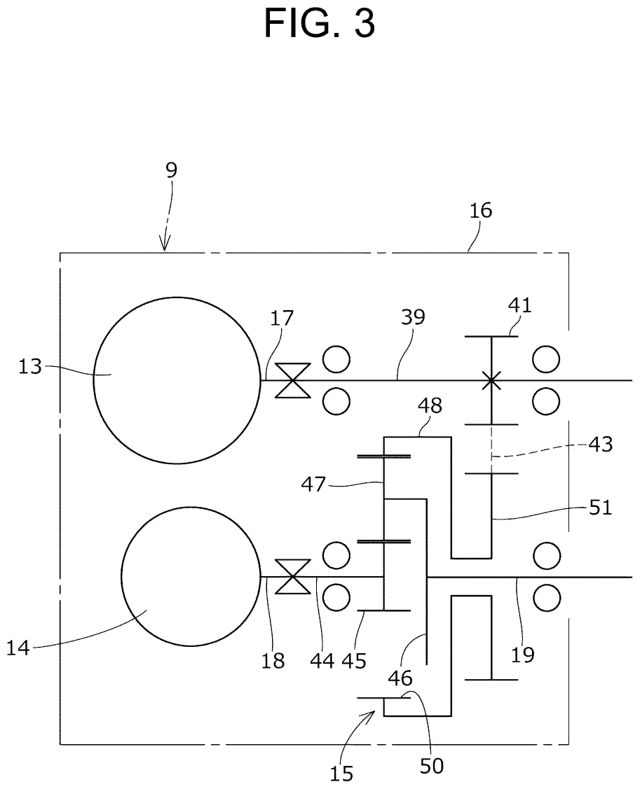

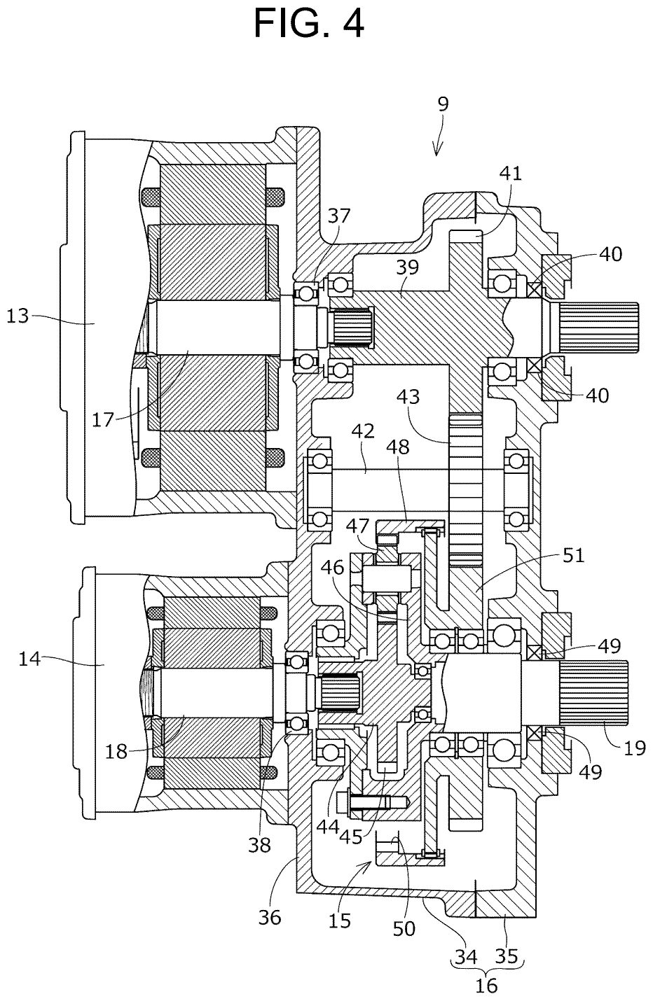

As illustrated in detail in FIG. 4, an idle shaft 42 extending in parallel with the work-machine drive shaft 39 is rotatably supported at a vertically intermediate portion in the casing 16. An idle gear 43 is fixed to a longitudinally intermediate portion of the idle shaft 42. The output branching gear 41 of the work-machine drive shaft 39 is always engaged with the idle gear 43. The idle shaft 42 is not illustrated in FIG. 2 and FIG. 3.

The planetary gear mechanism 15 serving as a power combining mechanism is disposed in a lower portion of the casing 16. The planetary gear mechanism 15 includes a sun gear 45 fixed to a sun gear shaft 44 coaxial with the travel motor shaft 18, a hollow carrier 46 rotatably supporting a plurality of planetary gears 47 on the same radius, and a ring gear 48 having internal teeth on an inner circumferential surface thereof. The distal end side of the travel motor shaft 18 is inserted into the proximal end side of the sun gear shaft 44 so as not to be relatively rotatable. Therefore, the sun gear shaft 44 and the sun gear 45 rotate integrally with the travel motor shaft 18. The sun gear 45 meshes with the respective planetary gears 47 of the carrier 46 from the radially inner side.

The carrier 46 is rotatably supported by the casing 16. The sun gear shaft 44 is rotatably inserted into the carrier 46. The travel drive shaft 19 is integrally provided on a portion of the carrier 46 on the side opposite to the travel motor shaft 18. A front middle portion of the travel drive shaft 19 is rotatably supported by the lid portion 35. The travel drive shaft 19 penetrates through the lid portion 35, and the distal end side thereof protrudes to the outside from the casing 16. The opening portion of the lid portion 35 through which the travel drive shaft 19 is inserted is closed by an annular seal 49 fitted to the travel drive shaft 19.

The ring gear 48 is rotatably fitted on the travel drive shaft 19 extending from the carrier 46. The internal teeth 50 on the inner circumferential surface of the ring gear 48 mesh with the respective planetary gears 47 of the carrier 46 from the radially outer side. A combining gear 51 that rotates integrally with the ring gear 48 is also rotatably supported on the travel drive shaft 19. The combining gear 51 is constantly meshed with the idle gear 43. That is, the output branching gear 41 of the work-machine drive shaft 39 can transmit power to the combining gear 51 via the idle gear 43. In the first embodiment, the ring gear 48 and the combining gear 51 have an integral structure. The travel motor shaft 18, the sun gear shaft 44, the sun gear 45, the carrier 46, the ring gear 48, the combining gear 51, and the travel drive shaft 19 are all positioned coaxially.

As illustrated in FIG. 2 to FIG. 4, the work-machine drive shaft 39 and the travel drive shaft 19 extending from the planetary gear mechanism 15 protrude from the casing 16 to the outside in the same direction (in the first embodiment, protrude rearward in parallel to each other). The distal end side (rear end side) of the work-machine drive shaft 39 is interlockingly connected to the PTO transmission shaft 31 of the transmission case 8, and the distal end side (rear end side) of the travel drive shaft 19 is interlockingly connected to the travel input shaft 24 of the transmission case 8.

When both the work electric motor 13 and the travel electric motor 14 are driven, the corresponding motor shafts 17 and 18 rotate. A portion of the output of the work motor shaft 17 is transmitted to the ring gear 48 via the output branching gear 41, the idle gear 43, and the combining gear 51 of the work-machine drive shaft 39. The output of the travel motor shaft 18 is transmitted to the sun gear 45 of the sun gear shaft 44. Since each planetary gear 47 is constantly meshed with both the internal teeth 50 of the ring gear 48 and the sun gear 45, the output via the ring gear 48 and the output via the sun gear 45 are combined by the plurality of planetary gears 47 and transmitted to the carrier 46 and thus to the travel drive shaft 19. The combined output (transmission output) transmitted to the travel drive shaft 19 is transmitted to the travel input shaft 24 of the transmission case 8. The remaining output of the work motor shaft 17 is transmitted to the PTO transmission shaft 31 of the transmission case 8 via the work-machine drive shaft 39.

According to the electric transmission 9 of the first embodiment, both electric motors 13 and 14 and the planetary gear mechanism 15 are assembled to a common casing 16 to form a unit, and the output of the work electric motor 13 and the combined output of the planetary gear mechanism 15 can be respectively taken out from the casing 16, so that both electric motors 13 and 14 and the planetary gear mechanism 15 can be easily assembled to a power transmission such as a transmission case 8 as a single unit of the electric transmission 9. That is, the electric transmission 9 can be shared among different models and specifications, and can be easily adapted to, for example, a plurality of models and specifications of agricultural tractors only by developing variations of power transmissions such as the transmission case 8 except for the electric transmission 9. Therefore, the efficiency of the assembling work can be improved, and the cost for developing variations can be reduced.

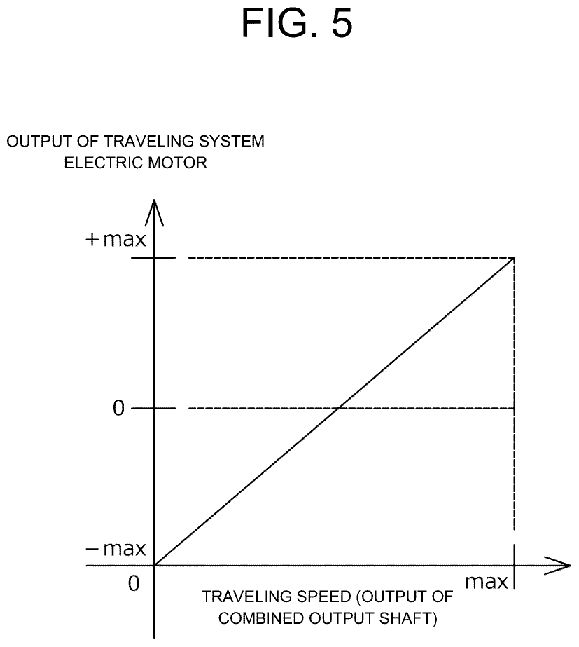

As described above in the first embodiment, the work electric motor 13 is structured to maintain the rotation speed (output) at the optimum predetermined rotation speed as the work rotation on one side in the rotation direction, regardless of the load fluctuation. On the other hand, the travel electric motor 14 is structured to be rotatable in forward and reverse directions and to be capable of steplessly (continuously) changing its output. FIG. 5 is an output characteristic diagram illustrated the relationship between the traveling speed of the agricultural tractor (which may be referred to as the combined output of the planetary gear mechanism 15) and the output of the travel electric motor 14. This is an example in a state in which the output (rotational speed) of the work electric motor 13 is held substantially constant regardless of load fluctuation. As can be seen from FIG. 5, the planetary gear mechanism 15 is structured such that the combined output (transmission output) is maximized when the output of the travel electric motor 14 is maximized in one direction (here, maximized in the plus (+, positive) direction), and the combined output (transmission output) is minimized or zero when the output of the travel electric motor 14 is maximized in the other direction (here, maximized in the minus (−, reverse) direction).

Therefore, the output characteristics of the travel electric motor 14 can be used in a wide range from the maximum in one direction to the maximum in the other direction without being limited to a narrow range from zero to the maximum in one direction or the other direction. Even if the capacity of the travel electric motor 14 is not increased, it is possible to reliably achieve the expansion of the shiftable range using the power combining function of the planetary gear mechanism 15, to reduce the weight and cost of the travel electric motor 14 and thus the electric transmission 9, and to increase the output of the planetary gear mechanism 15.

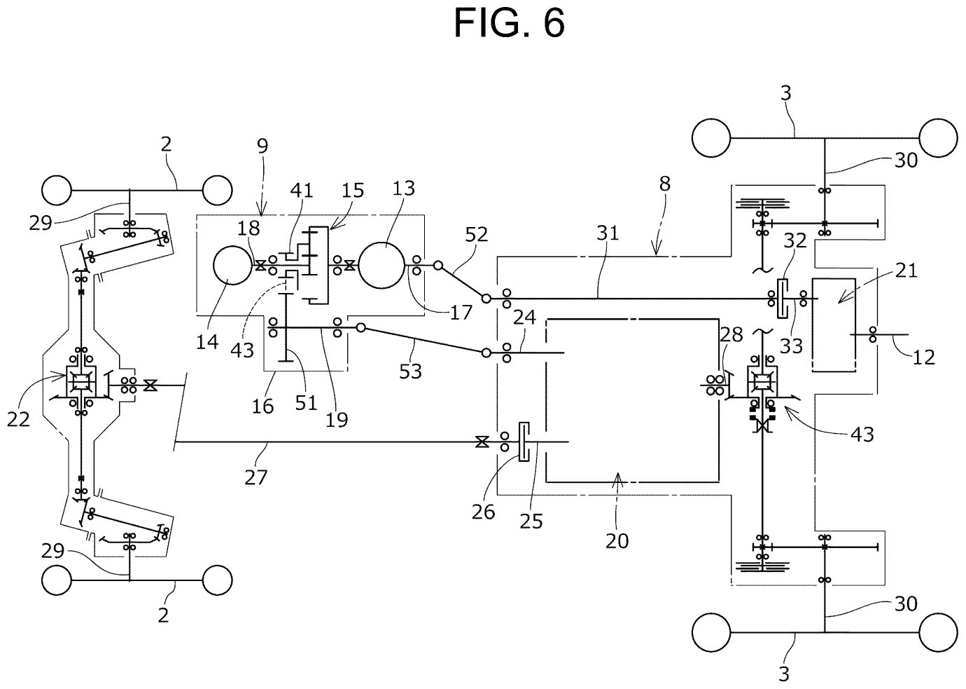

A tractor employing the electric transmission 9 of a second embodiment will now be described with reference to FIG. 6 to FIG. 8. In the description of the second and subsequent embodiments, the same components as those of the first embodiment described above are denoted by the same reference numerals as those of the first embodiment, and the detailed description thereof will be omitted.

In the second embodiment, the work electric motor 13 and the travel electric motor 14 are separately disposed on the front and rear sides of the upper portion of the casing 16. The work electric motor 13 is attached to the lid portion 35, and the travel electric motor 14 is attached to the front wall 36 of the main body portion 34. That is, the work electric motor 13 and the travel electric motor 14 are disposed in the casing 16 along the front-rear direction of the vehicle body.

The work motor shaft 17 protrudes from the base portion of the work electric motor 13 to both front and rear sides. The front end side of the work motor shaft 17 penetrates the lid portion 35 and protrudes into the casing 16. The rear end side of the work motor shaft 17 protrudes from the base portion of the work electric motor 13 to the outside. Therefore, the work motor shaft 17 protrudes from the lid portion 35 of the casing 16 to the outside via the base portion of the work electric motor 13. The rear end side of the work motor shaft 17 is interlockingly connected to the PTO transmission shaft 31 of the transmission case 8 via a work-power relay shaft 52 having universal joints at the front and rear. The front end side of the work motor shaft 17 is rotatably supported by the lid portion 35 via the sealed bearing 37. The travel motor shaft 18 penetrates through the front wall 36 of the main body portion 34, and the distal end side (rear end side) thereof protrudes into the casing 16. The travel motor shaft 18 is rotatably supported by the front wall 36 of the main body portion 34 via a sealed bearing 38.

The planetary gear mechanism 15 serving as a power combining mechanism is disposed in an upper portion of the casing 16. The planetary gear mechanism 15 of the second embodiment includes the sun gear 45 fixed to the sun gear shaft 44 coaxially connected with the travel motor shaft 18, the hollow carrier 46 rotatably supporting the plurality of planetary gears 47 on the same radius, and the ring gear 48 having internal teeth on an inner circumferential surface thereof. The distal end side of the travel motor shaft 18 is inserted into the proximal end side of the sun gear shaft 44 so as not to be relatively rotatable. Therefore, the sun gear shaft 44 and the sun gear 45 rotate integrally with the travel motor shaft 18. The sun gear 45 meshes with the respective planetary gears 47 of the carrier 46 from the radially inner side.

The front end side of the carrier 46 is rotatably supported by the front wall 36 of the main body portion 34. The sun gear shaft 44 is rotatably inserted into the carrier 46. The rear end side of the carrier 46 is rotatably supported by the ring gear 48. The ring gear 48 is rotatably supported by the lid portion 35 via a bearing in a state of being interlockingly connected to the front end side of the work motor shaft 17. The internal teeth 50 on the inner circumferential surface of the ring gear 48 mesh with the respective planetary gears 47 of the carrier 46 from the radially outer side. The output branching gear 41 is fitted on the front end side (a portion surrounding the sun gear shaft 44) of the carrier 46 so as not to be relatively rotatable. In the second embodiment, the travel motor shaft 18, the sun gear shaft 44, the sun gear 45, the carrier 46, the ring gear 48, and the output branching gear 41 are all positioned coaxially.

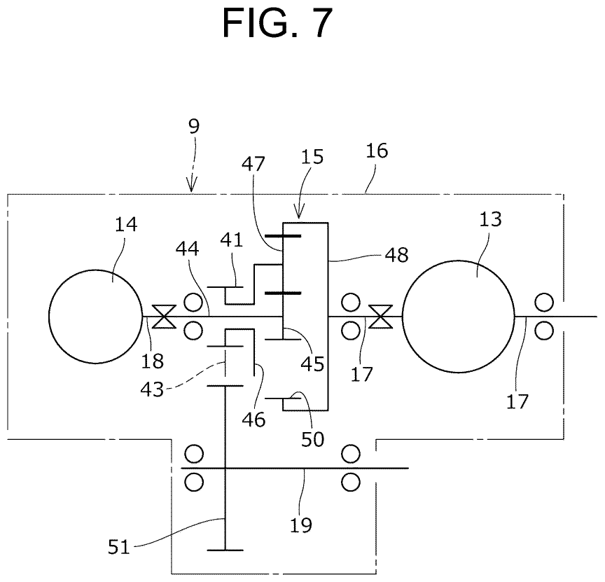

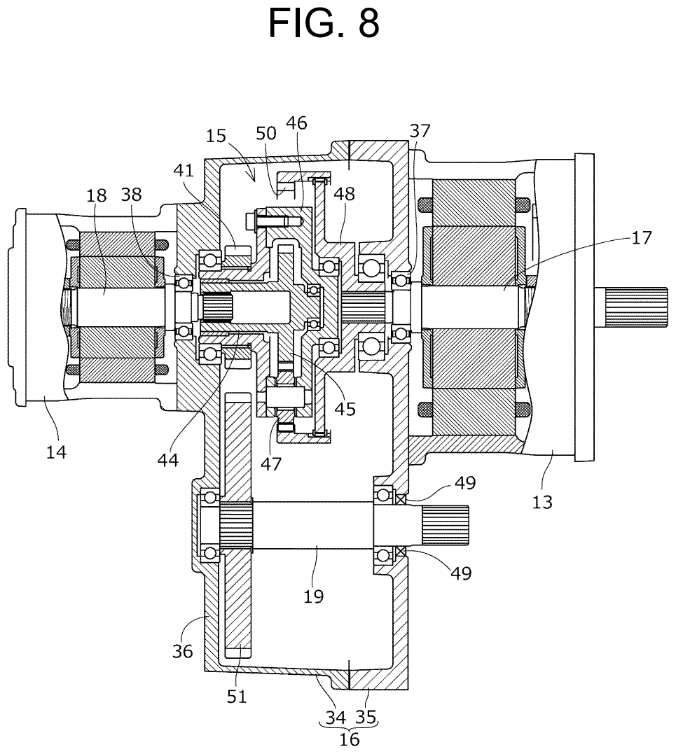

FIG. 6 and FIG. 7 do not illustrate the idle shaft 42 rotatably supported at a vertically intermediate portion in the casing 16. FIG. 8 does not illustrate the idle shaft 42 and the idle gear 43 provided thereon.

The travel drive shaft 19 extending in parallel with the motor shafts 17 and 18 and the sun gear shaft 44 is rotatably supported in a lower portion of the casing 16. The distal end side (rear end side) of the travel drive shaft 19 penetrates the lid portion 35 and protrudes to the outside from the casing 16. The distal end side (rear end side) of the travel drive shaft 19 is interlockingly connected to the travel input shaft 24 of the transmission case 8 via a travel-power relay shaft 53 having universal joints at the front and rear. The opening portion of the lid portion 35 through which the travel drive shaft 19 is inserted is closed by the annular seal 49 fitted to the travel drive shaft 19. The combining gear 51 is fitted on the travel drive shaft 19 so as not to be relatively rotatable. The output branching gear 41 of the carrier 46 always meshes with the idle gear 43 (not illustrated), and similarly, the combining gear 51 also always meshes with the idle gear 43. That is, the output branching gear 41 of the carrier 46 can transmit power to the combining gear 51 via the idle gear 43.

As illustrated in FIG. 6 to FIG. 8, the work motor shaft 17 constituting the work-machine drive shaft and the travel drive shaft 19 to which the output of the planetary gear mechanism 15 is transmitted protrude from the casing 16 to the outside in the same direction (also, in the second embodiment, protrude rearward in parallel to each other).

When both the work electric motor 13 and the travel electric motor 14 are driven, the respective motor shafts 17 and 18 are rotated. A portion of the output of the work motor shaft 17 is transmitted from the front end side thereof to the ring gear 48. The output of the travel motor shaft 18 is transmitted to the sun gear 45 of the sun gear shaft 44. Since each planetary gear 47 always meshes with both the internal teeth 50 of the ring gear 48 and the sun gear 45, the output via the ring gear 48 and the output via the sun gear 45 are combined by the plurality of planetary gears 47 and transmitted from the carrier 46 to the travel drive shaft 19 via the output branching gear 41, the idle gear 43, and the combining gear 51. The combined output (transmission output) transmitted to the travel drive shaft 19 is transmitted to the travel input shaft 24 of the transmission case 8. The remaining output of the work motor shaft 17 is transmitted from the rear end side thereof to the PTO transmission shaft 31 of the transmission case 8.

Also, in the case of the configuration as in the second embodiment, the electric transmission 9 can be shared between different models or specifications, and can be easily adapted to, for example, a plurality of models or specifications of agricultural tractors only by developing variations of the power transmission such as the transmission case 8 except for the electric transmission 9. That is, it is possible to provide the electric transmission 9 similar to that of the first embodiment, which can improve the assembling workability (assembling efficiency) and can reduce the cost for developing variations.

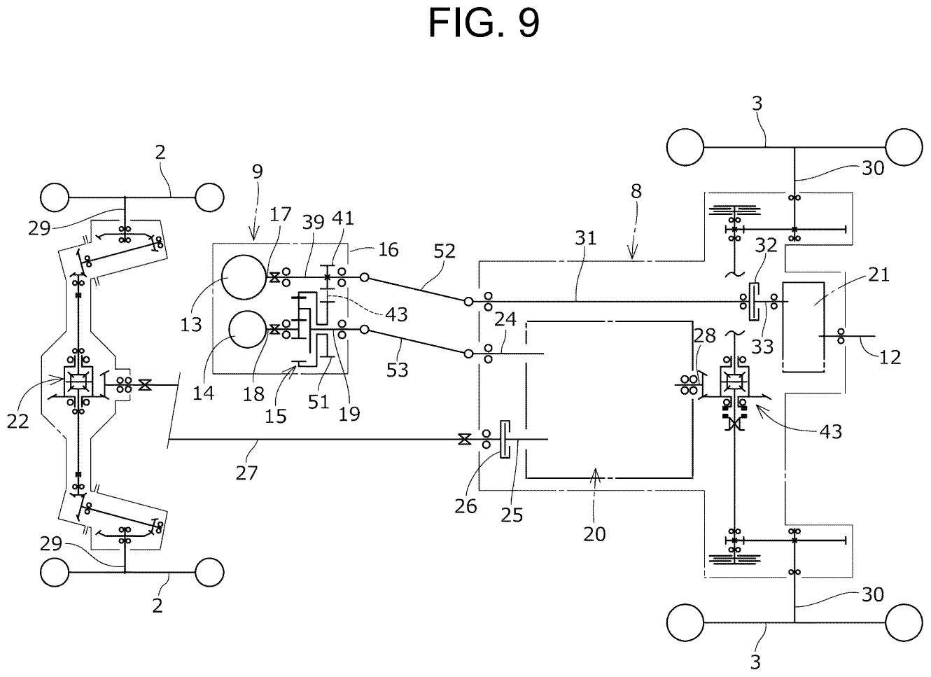

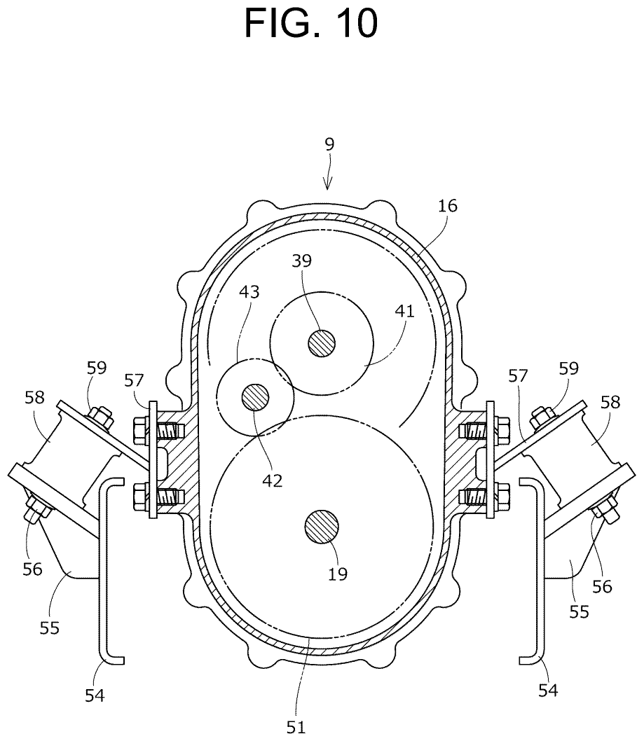

An agricultural tractor employing the electric transmission 9 of a third embodiment will now be described with reference to FIGS. 9 and 10. The electric transmission 9 of the third embodiment basically has the same configuration as that of the first embodiment. However, in the third embodiment, the distal end side (rear end side) of the work-machine drive shaft 39 is interlockingly connected to the PTO transmission shaft 31 of the transmission case 8 via the work-power relay shaft 52 and is interlockingly connected to the travel input shaft 24 of the transmission case 8 via the travel-power relay shaft 53 of the travel drive shaft 19.

As illustrated in FIG. 10, in the third embodiment, the agricultural tractor includes a pair of right and left machine body frames 54 constituting the traveling machine body 1. The electric transmission 9 is provided with a pair of vibration isolating members at least on the right and left outer sides of the casing 16. The electric transmission 9 can be supported on the machine body frames 54 in a vibration-proof manner via a pair of vibration isolating members. In this case, the pair of left and right machine body frames 54 are provided with machine body brackets 55 protruding outward in the left-right direction in an intermediate portion in the front-rear direction. The electric transmission 9 is elastically supported by the pair of right and left machine body brackets 55 via a vibration isolating rubber 58 serving as a vibration isolating member.

The machine body brackets 55 are respectively fixed to the right and left outer surface sides of the corresponding machine body frames 54 by welding or the like. A nut 56 is fixed to the lower surface side of the machine body bracket 55 by welding or the like. A case receiving plate 57 corresponding to the machine body bracket 55 is bolted to both right and left outer wall surfaces of the casing 16 in the electric transmission 9. The vibration isolating rubber 58 is arranged between the case receiving plate 57 and the machine body bracket 55 opposed to each other, and a bolt 59 passing through the case receiving plate 57 and the vibration isolating rubber 58 is screwed into the nut 56 on the machine body bracket 55 side, so that the case receiving plate 57 and the machine body bracket 55 sandwich the vibration isolating rubber 58. As a result, the electric transmission 9 is elastically supported by the machine body frames 54 and the traveling machine body 1 via the pair of left and right vibration isolating rubber 58.

According to the configuration of the third embodiment, since the electric transmission 9 is supported in a vibration-proof manner relative to the machine body frames 54 and the traveling machine body 1, it is possible to suppress the propagation of vibration from the ground during traveling to the electric transmission 9, and it is possible to provide the electric transmission 9 having excellent durability by reducing problems such as failure of the electric transmission 9 due to vibration.

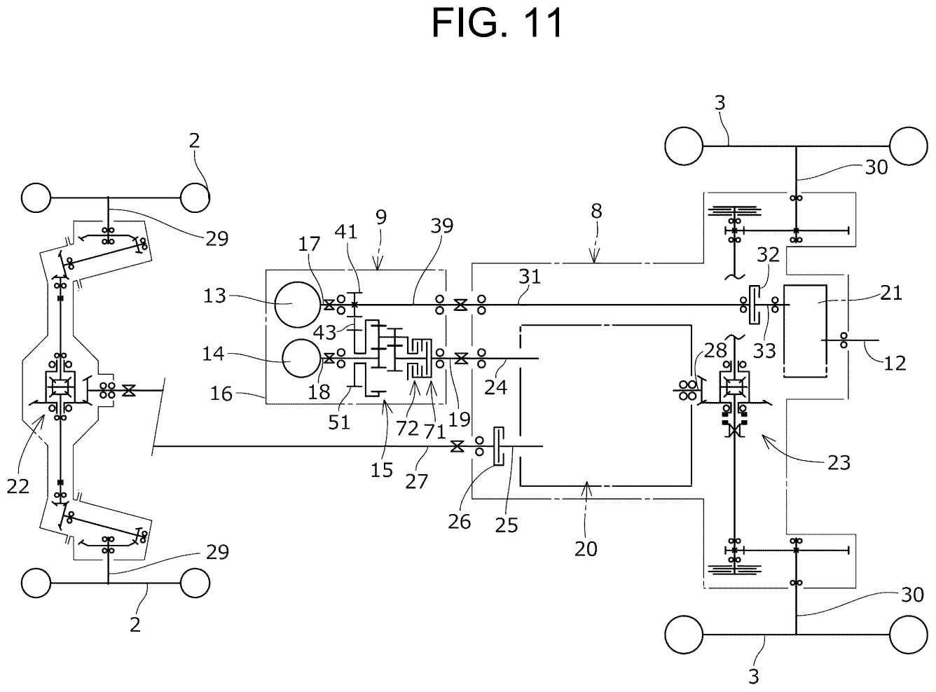

A tractor employing the electric transmission 9 according to a fourth embodiment will now be described with reference to FIG. 11 to FIG. 13. The electric transmission 9 of the fourth embodiment is basically the same as that of the first embodiment. However, the planetary gear mechanism 15 of the fourth embodiment includes two sun gears 65 and 70 and a plurality of double planetary gears 67.

That is, the planetary gear mechanism 15 of the fourth embodiment includes a first sun gear 65 fixed to a first sun gear shaft 64 that is coaxial with and rotates integrally with the travel motor shaft 18, a second sun gear shaft 69 disposed coaxially with and relatively rotatably with respect to the travel motor shaft 18 and the first sun gear shaft 64, a second sun gear 70 fixed to the second sun gear shaft 69, the double planetary gears 67 (67a and 67b), a carrier 66 having the double planetary gears 67 axially supported on the same rotation locus, a ring gear 68 including internal teeth 73 on an inner circumferential surface, a low-speed clutch 71, a high-speed clutch 72, and a clutch switching control device.

The first sun gear 65 meshes with the first planetary gear 67a of the double planetary gears 67 from the radially inner side. The second sun gear 70 meshes with the second planetary gear 67b of the double planetary gears 67 from the radially inner side. The second sun gear shaft 69 is connected to the travel drive shaft 19 extending rearward from the planetary gear mechanism 15 via the low-speed clutch 71 so that power can be connected and disconnected.

The carrier 66 is rotatably fitted on the second sun gear shaft 69. The carrier 66 is connected to the travel drive shaft 19 via the high-speed clutch 72 so that power can be connected and disconnected. The internal teeth 73 of the ring gear 68 mesh with the first planetary gear 67a of the double planetary gears 67 from the outside in the radial direction. The ring gear 68 and the combining gear 51 that rotates integrally with the ring gear 68 are rotatably fitted on the first sun gear shaft 64.

The work-machine drive shaft 39 outputs a predetermined constant rotation toward the outside. The output branching gear 41 located in the casing 16 can transmit the constant rotation of the work electric motor 13 to the combining gear 51 via the idle gear 43. In the fourth embodiment, the ring gear 68 and the combining gear 51 have an integral structure. The travel motor shaft 18, the first sun gear shaft 64, the first sun gear 65, the second sun gear 70, the second sun gear shaft 69, the carrier 66, the ring gear 68, the combining gear 51, and the travel drive shaft 19 are all positioned coaxially.

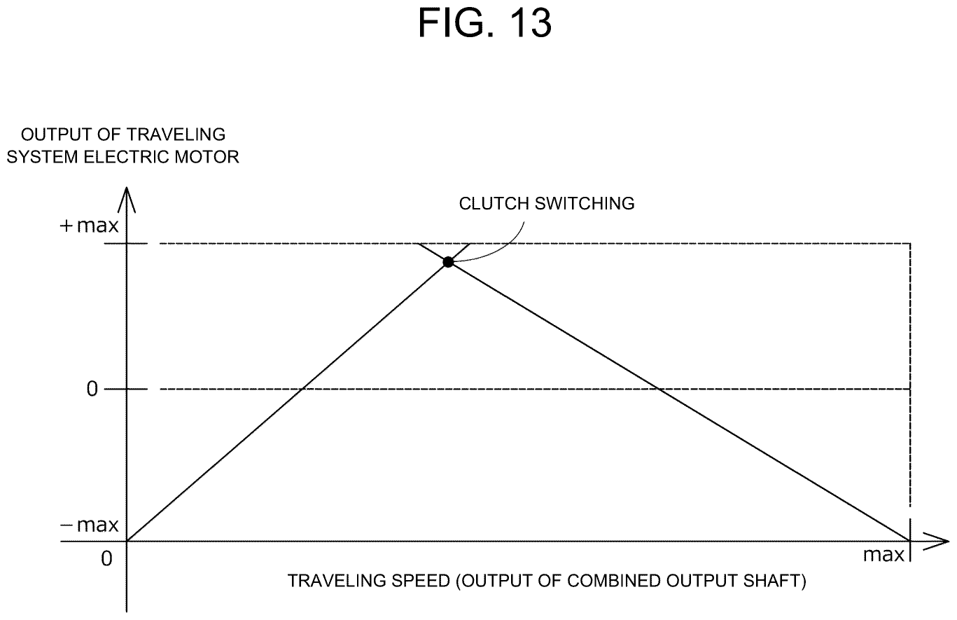

FIG. 13 is an output characteristic diagram illustrated the relationship between the traveling speed of the agricultural tractor (combined output of the planetary gear mechanism 15) according to the fourth embodiment and the output of the travel electric motor 14. The output characteristic diagram is an example in a state in which the work electric motor 13 is controlled so as to output a constant rotational speed corresponding to an appropriate speed of the work machine regardless of the load fluctuation. In order to obtain this characteristic, the control device is provided with various sensors for shift operation signals and traveling speed.

In the planetary gear mechanism 15 of the fourth embodiment, in a state where the low-speed clutch 71 is engaged, the combined output (transmission output) is minimum or zero when the output of the travel electric motor 14 is maximum in the other direction (here, the minus (−, reverse) direction). As the speed of the travel electric motor 14 increases in one direction (here, the plus (+, positive) direction), the rotation of the carrier 66 is multiplied by the gear ratio of the gears 67b and 70 and transmitted to the second sun gear 70 through the revolution and rotation of the second planetary gears 67b, and the output speed of the travel drive shaft 19 in increased by the second sun gear shaft 69.

The clutch to be connected is switched from the low-speed clutch 71 to the high-speed clutch 72 at the time when the speed becomes substantially maximum (at a point indicated as “clutch switching” in FIG. 13). Then, the power transmission from the second sun gear shaft 69 to the travel drive shaft 19 is cut off, and the power from the carrier 66 is transmitted to the travel drive shaft 19. The rotation of the carrier 66 is transmitted to the travel drive shaft 19 without passing through the gear ratio of the gears 67b and 70. Next, as the output of the travel electric motor 14 becomes the maximum in the other direction (here, the minus (−, reverse) direction), the combined output (transmission output) increases, and when the output of the travel electric motor 14 becomes the maximum in the other direction (here, the minus (−, reverse) direction), the output speed of the travel drive shaft 19 becomes the maximum. The gear ratios (parameters) of each gear are designed so that the speed can be synchronized before and after the clutch is switched.

Therefore, in the fourth embodiment, as compared with the first to third embodiments, a wider range can be achieved by output division, and the shiftable range using the planetary gear mechanism 15 can be further expanded.

The configurations of the above-described embodiments are not limited to those illustrated in the drawings, and various modifications can be made without departing from the spirit of the present invention. For example, the electric transmission of the present invention can be applied not only to agricultural work machines (such as combines and tractors) but also to construction machines (such as hydraulic excavators and forklifts).

### REFERENCE SIGNS LIST

8 transmission case
9 electric transmission
12 PTO shaft
13 work electric motor
14 travel electric motor
15 planetary gear mechanism (power combining mechanism)
16 casing
17 work motor shaft
18 travel motor shaft
19 travel drive shaft
34 main body portion
35 lid portion
36 front wall
39 work-machine drive shaft
41 output branching gear
43 idle gear
45 sun gear
46 carrier
47 planetary gear
48 ring gear
50 internal teeth
51 combining gear

1. An electric transmission comprising:
a work electric motor;
a travel electric motor; and
a power combining mechanism that combines output of both of the electric motors, wherein,
at least the output of the travel electric motor is variably controlled to change the output of the power combining mechanism,
both of the electric motors and the power combining mechanism are assembled in a common casing to form a unit, and
the output of the work electric motor and the output of the power combining mechanism are respectively taken out from the casing.

2. The electric transmission according to claim 1, wherein a work-machine drive shaft to which the output of the work electric motor is transmitted and a travel drive shaft to which the output of the power combining mechanism is transmitted are supported in parallel by the casing and protrude outward in a same direction.

3. The electric transmission according to claim 1, wherein rated power output of the work electric motor is greater than rated power output of the travel electric motor.

4. The electric transmission according to claim 1, wherein the power combining mechanism is structured such that transmission output of the power combining mechanism is maximized when the output of the travel electric motor is maximized in one direction, and transmission output of the power combining mechanism is minimized or zero when the output of the travel electric motor is maximized in another direction.

5. A work vehicle comprising:
the electric transmission according claim 1; and
a machine body frame,
wherein the electric transmission is structured to be supported on the machine body frame in a vibration-proof manner via a pair of vibration isolating members on at least right and left outer side portions of the casing.
